(19) United States
(12) Patent Application Publication
(10) Pub. No.: US 2026/0254610 A1
(43) Pub. Date: Aug. 27, 2026

(54) METHOD FOR HOMOMORPHICALLY DETERMINING THE SIGN OF A MESSAGE BY DILATION, ASSOCIATED METHODS AND DEVICES

(71) Applicant: RAVEL TECHNOLOGIES, PARIS (FR)

(72) Inventors: Philippe CHARTIER, PARIS (FR); Michel KOSKAS, PARIS (FR); Mohammed LEMOU, PARIS (FR); Florian MEHATS, PARIS (FR)

(21) Appl. No.: 18/875,864

(22) PCT Filed: Jun. 16, 2023
(86) PCT No.: PCT/EP2023/066324

§ 371 Date: Dec. 17, 2024

(30) Foreign Application Priority Data
Jun. 17, 2022 (FR) FR2205957

(51) Int. Cl. H04L 9/00

(52) U.S. Cl. CPC H04L 9/008

(57) ABSTRACT

A method for homomorphically determining the positive or negative character of a message μ from a corresponding encrypted message c, encrypted by a learning-with-errors type method, the message μ belonging to the discrete torus Tₚ or to a space in bijection with Tₚ, with formula (p), the integers pi being mutually prime, the encrypted message c being made up of q components Cᵢ, with formula (c), vᵢ being the Bézout coefficient associated with the integer pᵢ. The method comprises at least one dilation of the encrypted message c in accordance with formula (c^{[1]}), where p is an odd number greater than or equal to 3. The method also includes merging quantities representative of the sign of c and the sign of c^{[1]}.

### TECHNICAL FIELD

The technical field is that of homomorphic cryptographic methods, devices and systems.

### TECHNOLOGICAL BACKGROUND

Homomorphic cryptography, which makes it possible to perform calculations or data processing on encrypted data without first decrypting them, has attracted a lot of attention recently.

Indeed, the digital processing of personal data has become ubiquitous in our daily lives. Protecting the confidentiality of these data, and the privacy of the individuals concerned, has therefore become critical, as these personal data tend to circulate more and more in the digital environments and systems used on a daily basis.

In this context, encryption and homomorphic processing techniques appear to be a very promising solution, as they make it possible to process data while preserving anonymity and privacy of these data in a particularly secure way, as the data are not decrypted during processing.

Homomorphic cryptography methods therefore meet, among other things, the technical challenge of enabling:
an external, usually remote, service and processing server to perform “blind” operations on encrypted data, without decrypting them, as this server does not have the key needed to decrypt the data,
the encrypted data being provided by another, distinct entity (a client, in the computational sense), which has the encryption key available.

These data processing operations can consist in performing individual operations, piece of data by piece of data, to format or filter them, for example. But the most notable applications relate to operations of comparing, sorting or grouping data. It is therefore very useful to have tools that enable comparisons between data to be made efficiently and homomorphically.

Homomorphic cryptography can be based on the “Learning With Errors” (LWE) encryption scheme, in which the encrypted message c=(a,b) is derived from the unencrypted message μ according to the following formula: b=μ+e+a·s, where:
s is a secret key,
a is a randomly selected vector to project the secret key s, and
e is a random noise component added to μ+a·s.

To decrypt the message, a person with the secret key s can calculate the quantity b−a·s (equal to μ+e), and then round off the result to remove the noise component e and recover the message μ. Of course, the noise term e should be and remain sufficiently small if the message μ is to be recovered.

When two encrypted messages are added together, the result is an encrypted message, which is an encrypted version of the sum (of the two original non-enciphered messages, with a higher noise component than the two original enciphered messages).

Thus, to prevent the noise term from increasing and growing during data processing, a refresh procedure, usually referred to as “bootstrapping”, is repeatedly executed. This procedure produces a refreshed version of c, i.e. an enciphered message c′ which is also deciphered as u (when deciphered using s), but whose noise component is smaller than that of c. This bootstrapping procedure is extremely useful and ingenious, but it is also very consuming, in terms of computational resources (in particular because the operations involved have to be performed homomorphically), all the more so because it has to be performed very regularly.

The homomorphic encryption scheme described above, which combines “learning with error” and bootstrapping, thus has the drawback of being generally very cumbersome to implement, requiring a great deal of computational power or time.

To facilitate the operations in question, it is generally chosen to operate on binary messages (i.e. messages whose value is either 0 or 1). The complex tools (especially for bootstrapping) that have been developed to implement this type of cryptographic scheme are thus tools adapted to binary messages.

To perform homomorphic operations on a longer message, the message is decomposed into binary messages (conventional binary decomposition), each binary message is separately enciphered, and the operation is then homomorphically performed, bit by bit. However, in this process, the (encrypted) carried number resulting from each addition or binary operation should be taken into account, and this carried number should be propagated to the next binary operation. It is therefore a serial process, highly consuming especially in terms of calculation time. Moreover, each binary operation is homomorphically performed, which multiplies the number of homomorphic (and therefore time-consuming) operations.

In this context, it would therefore be useful to have a homomorphic cryptography technique that is more computationally efficient and especially adapted to database processing operations, for example of the comparison or sorting type.

### SUMMARY

The present technology then relates to a method for homomorphically determining the positive or negative character of a message u from a corresponding encrypted message c, without decrypting the encrypted message c, the encrypted message c corresponding to the message μ encrypted by a learning-with-error type method,
the message μ belonging to the discrete torus

$${T}_{p} = \frac{1}{p} \{ - \frac{p - 1}{2} , - \frac{p - 1}{2} + 1 , … , \frac{p - 1}{2} - 1 , \frac{p - 1}{2} \}$$

or to a space in bijection with Tₚ, with

$$p = {\prod }_{i = 1}^{i = q} {p}_{i} ,$$

the integers pᵢ being mutually prime, the encrypted message c being formed of q components cᵢ, with

$$c = {\sum }_{i = 1}^{i = q} {v}_{i} {c}_{i} mod ( 1 ) ,$$

vᵢ being the Bézout coefficient associated with the integer pᵢ, defined by uᵢ pᵢ+vᵢ p/pᵢ=1,
the method comprising:
   a scaling step, comprising determining a dilated encrypted message c^{[1]} in accordance with the following formula

$${c}^{[ 1 ]} = {\sum }_{i = 1}^{i = q} [ \overline{p} {v}_{i} mod ( {p}_{i} ) ] {c}_{i} mod ( 1 ) ,$$

where p̅ is an odd number greater than or equal to 3, and
a merging step, comprising calculating the sum F₀(c)+F₁(c^{[1]}) where F₀ and F₁ respectively designate an operation of homomorphically calculating a quantity att_{[0]}·g_{ε}, and a quantity att_{[1]}·g_{ε}, g_{ε} being a staircase function which is zero on a central interval]−ε/2, ε/2[ and which has two distinct values on either side of this central interval, the coefficient att_{[1]} being less than the coefficient att_{[0]}.

The coefficients att_{[0]} and att_{[1]} are, for example, such that (att_{[0]}+att_{[1]})·g_{ε} remains between −½ and ½.

The decomposition of the encrypted message c into its q independent components cᵢ, and the recomposition of the message c from these components cᵢ are performed by applying the Chinese remainder theorem.

The corresponding plaintext message, μ, can additionally be decomposed into q components μᵢ (and recomposed from these), in the same way.

Numerous operations on the encrypted message c, for example a homomorphic addition (FIG. 6), a homomorphic multiplication (FIG. 7), or a bootstrap operation, can be made component by component, by processing the q components cᵢ of the message c, independently of each other, without having to propagate any carried number between them.

One take thus advantage of the particular decomposition of the Chinese theorem to process the different components cᵢ of the encrypted message c independently and in parallel, which speeds up processing relative to a binary decomposition with propagation of (encrypted) carried numbers.

It is to be noted that the different components cᵢ correspond to encrypted “sub-messages”, each associated (by encryption) with one of the “sub-messages” μᵢ making up the total plaintext message μ (FIG. 5).

Planning to use such a decomposition to develop a more efficient homomorphic cryptography technique is far from immediate. Indeed, as mentioned above, most of the homomorphic cryptography tools currently available are specifically adapted to binary messages. Thus, to develop such a technique, it was necessary to go against usual practices and prejudices and develop specific (and elaborate) tools intended for messages longer than just binary (i.e. to process sub-messages μᵢ, which are not just binary, with two values, since they can take pᵢ values, with pᵢ=3, 7, 11 or even 17, for example), without even knowing whether direct homomorphic processing of “long” messages was really possible or not, or whether it could be carried out efficiently or not. In particular, setting up such an encryption scheme required to devise a new homomorphic multiplication scheme and a new bootstrapping method. It was only once these new tools had been developed that the inventors could be sure of the feasibility and interest of such a scheme, to be decomposed via the Chinese remainder theorem.

These new tools (new bootstrapping, and new homomorphic multiplication for non-binary “long” sub-messages) are described in detail in patent application PCT/IB2020/001147, which has not yet been published, and which has been filed by the same applicant.

This advance, based on these new homomorphic calculation tools, and on this use of the Chinese remainder theorem, makes it possible to process long messages (which can take on 7×11×13×17×19=323323 different values, for example).

Nevertheless, as mentioned in the preamble, a very useful operation in the field of data processing (in particular for processing databases of a personal or private nature) is the comparison of two messages (of two data) with each other, for example to sort a database or to make extractions therefrom.

One way of comparing two messages (to determine which is greater) is to calculate their difference, and then determine the sign of the difference.

The homomorphic calculation of the difference between two messages, constructed as described above (from independent sub-messages, via the Chinese remainder theorem), does not pose any particular difficulty, and can be made component by component. On the other hand, homomorphically determining the sign of such a message presents difficulties.

Indeed, the sign of the “complete” message μ is unrelated to the respective signs of the different components μᵢ of which it is composed. The sign of the message μ cannot therefore be determined component by component.

This is illustrated by the following numerical example, where p=p₁×p₂=3×5. The two messages

$$\frac{2}{15} ∈ {T}_{15} and \frac{7}{15} ∈ {T}_{15}$$

both have a positive sign; their respective components are

$$( - \frac{1}{3} , \frac{2}{5} ) ∈ {T}_{3} \times {T}_{5} and ( \frac{1}{3} , \frac{2}{5} ) ∈ {T}_{3} \times {T}_{5} .$$

The signs of the message components are therefore (−1,1) for message 2/15, and (1,1) for message 7/15 even though these messages are both positive, which properly illustrates that the sign of the complete message cannot be deduced from the sign of its components.

However, determining the sign of the complete message μ, directly from the complete encrypted message c (and without decrypting its components), poses difficulties, because of the discontinuity of the sign function at 0 and because of the noise component e present in the complete encrypted message c

$$( with e = Err ( μ ) = {\sum }_{i = 1}^{i = q} {v}_{i} Err ( {μ}_{i} ) ) ,$$

which component is much larger than for the individual messages μᵢ. Thus, when μ is close enough to 0, because of this significant noise component for c, a reliable (homomorphic) determination of the positive or negative character of μ, directly from the encrypted message c, is no longer possible.

This difficulty is compounded by the fact that the values of μ, which belong to Tₚ, p=p₁× . . . ×p_{q}, can be much closer to 0 than the values of the individual messages μ₁ . . . μ_{q}, which belong to Tₚ₁, or Tₚᵢ. In other words, the different elements of the discrete torus Tₚ are much closer together than the elements of the discrete torus Tₚ₁, or Tₚᵢ (in addition to being affected by a larger noise component).

It will be noted that the difficulties in question arise when the value of μ is close to 0 or to the ends ½ and −½ of the torus. On the other hand, for values far from these points (for example, for values close to ¼ or −¼), a reliable determination of the sign of the message μ is possible directly, from its encrypted message c, via a bootstrapping operation including evaluating the sign function.

To overcome the above mentioned difficulty, two ingenious techniques have been developed by the inventors.

The first technique makes it possible to scale the message μ, more precisely to dilate it, by operating directly on its encrypted version c, without dilating (or dilating only slightly) the noise component e. This dilation operation, which may be made for several increasingly large dilation coefficients, makes it possible (if necessary) to bring the message out of the neighbourhood of 0 and into a zone where its sign can be reliably determined, with a very low probability of error, as schematically illustrated in FIG. 8.

This dilation of the message value, but not of the associated noise, is performed by calculating the dilated encrypted message c_{[1]} as follows:

$${c}^{[ 1 ]} = {\sum }_{i = 1}^{i = q} [ \overline{p} {v}_{i} mod ( {p}_{i} ) ] {c}_{i} mod ( 1 )$$

where the dilation coefficient p̅ is an odd number greater than or equal to 3.

Thus, in the sum

$${\sum }_{i = 1}^{i = q} {v}_{i} {c}_{i} ,$$

rather than multiplying the encrypted sub-message cᵢ by p̅ (which would increase its noise component), it is the coefficient vᵢ that is multiplied by p̅.

And as the Bézout coefficients are each defined to within pᵢ (i.e. modulo pᵢ), a reduced value for the “coefficient” [p̅vᵢ mod(pᵢ)] which multiplies cᵢ, in this sum, can be retained, which makes it possible to dilate c (more precisely: dilate μ), with virtually no dilation of its noise component e.

This noise-free dilation operation is very useful if the value of the message μ is close to 0, as explained above. On the other hand, if the value of μ is already large enough before dilation (for example close to ¼), the dilation operation, by increasing the value of μ, will modify its sign (due to the cyclicity of the torus), thus leading to an erroneous result. The message should therefore only be dilated if necessary.

But it is precisely in a homomorphic cryptography protocol that the initial value of the message is not known, and the operations are carried out in a sort of blind manner, always in encrypted form. Thus, it cannot be known, a priori, whether it is necessary to dilate the message, or whether, on the contrary, it is necessary to refrain from dilating it.

A second technique, implemented in this method, then consists in summing:
the sign (in its encrypted version) of the non-dilated message μ, given that 0 is assigned if the message μ is located in a zone of uncertainty, especially comprising a central interval, centred on 0, of width ε, with
the sign (in its encrypted version) of the dilated message μ_{[1]}, this sign being assigned an attenuation coefficient att_{[1]} which reduces its contribution, relative to the sign of the initial message μ.

Thus, if the initial message μ has a value large enough to determine its sign without error, it is the first term which will dominate this sum (by virtue of the attenuation coefficient att_{[1]}), and which will set the sign of the sum as a whole (while the sign of the dilated message, which is “false”, will have its contribution overwritten).

On the contrary, if the initial message is in the zone of uncertainty in question (with a sign that cannot be reliably determined), then, in this sum, the first term is zero, and the sign of the sum is set by the sign of the dilated message, which, on the contrary, this time has a correct value, corresponding to the sign of c itself.

This procedure, having a weighted sum with progressively smaller coefficients, can be generalised to cases where several successive dilations are required to escape the zone of uncertainty.

To homomorphically determine the sign of the message u from its encrypted message c, but assigning the value 0 to this result when the message is in the zone of uncertainty in question, a function g_{ε} or att_{[0]}·g_{ε} is applied homomorphically to μ (this function being applied when bootstrapping with integrated function calculation), where g_{ε} is a staircase function:
which is zero on a central interval]−ε/2, ε/2[,
which has two distinct values, for example −1 and +1 (case of FIG. 9), on either side of this central interval, and
which is zero near the ends of the torus, on the intervals]½−ε/2, ½[ and [−½, −½+ε/2[.

The two techniques mentioned above allow homomorphically determining the sign of a message, decomposed into sub-messages on the basis of the Chinese remainder theorem. More generally, they allow any piecewise constant function to be applied to such a message (for example the Heaviside function, or another function with more than two distinct pieces, on the interval [−½, ½[.

Further to the characteristics mentioned above, the method just set forth may include one or more of the following optional characteristics, considered individually or according to any technically feasible combination:
the scaling step comprises determinations of several dilated encrypted messages c^{[k]}, the integer k varying from 1 to K−1, each dilated encrypted message being determined in accordance with the following formula

$${c}^{[ k ]} = {\sum }_{i = 1}^{i = q} [ {\overline{p}}^{k} {v}_{i} mod ( {p}_{i} ) ] {c}_{i} mod ( 1 ) ,$$

and wherein the positive or negative character of the message μ is determined as a function of c and as a function of the different dilated encrypted messages c^{[k]}, k=1 . . . K−1,
the merging step comprises a packet merging step during which the following sum is calculated: F₀(c)+F₁(c^{[1]})+ . . . +Fₖ(c^{[k]})+ . . . +Fₘ(c^{[m]}), where Fₖ designates an operation of homomorphically calculating the quantity att_{[k]}·g_{ε}, where att_{[k]} is an attenuation coefficient less than 1, the series of coefficients att_{[k]}, k=0 . . . m being decreasing and such that: the sum of the attenuation coefficients, successive to one of the given attenuation coefficients of the series, is less than said given attenuation coefficient; this is, for example, a geometric series of common ratio less than ½;
m is less than K;
the merging step comprises the following steps
   S1: merging by packets, each packet grouping m terms, each merging of a packet corresponding to calculating the intermediate result resᵢ=F₀(c^{[(i-1)·m]})+F₁(c^{[(i-1)·m+1]})+ . . . +Fₖ(c^{[(i-1)·m+k]})+ . . . +Fₘ₋₁(c^{[i·m-1]}), where i is the packet number,
   S2: merging by packets of intermediate results resᵢ, each merging of a packet of m′ intermediate results corresponding to calculating a new intermediate result res′ⱼ=\tilde{F}₀(res_{m′·(j-1)})+\tilde{F}₁(res_{m′·(j-1)+1})+ . . . +\tilde{F}ₖ(res_{m′·(j-1)+k})+ . . . +\tilde{F}_{m′-1}(res_{m′·j-1}), j being the packet number, \tilde{F}ₖ designating an operation of homomorphically calculating a quantity att_{[k]}·g_{ε},
   step S2 being repeated until only a single result is obtained, to which the operation \tilde{F}₀ is applied, which provided a final result which is an encrypted version of the sign of the message μ.
the number K−1 of dilated encrypted messages taken into account is such that p̅^{K-1}>p/(p̅+1);
in which the width ε of the central interval is less than 1/(2p̅+1).

The present technology also relates to a method for homomorphically applying the Heaviside function H, which is zero for negative values and equal to 1 otherwise, the method comprising executing the method for determining the positive or negative character of the message u as described above, the function g_{ε} being selected to be zero for negative values and equal to 1 for positive values.

The present technology also relates to a method for homomorphically applying a piecewise constant function f to a message μ, the function f having t distinct pieces, the method comprising:
decomposing the function f as a linear combination of translated Heaviside functions, i.e.

$$f ( μ ) = {\sum }_{j = 1}^{j = t} {α}_{j} H ( μ - {β}_{j} ) ,$$

where the coefficients αⱼ are integers and the abscissas βⱼ of the discontinuity points belong to the interval [−¼, ¼],
calculating the quantity

$${\sum }_{j = 1}^{j = t} {α}_{j} H ( μ - {β}_{j} ) ,$$

each term H(μ−βⱼ) being homomorphically determined in accordance with the method for homomorphically applying the Heaviside function H just set forth.

The present technology also relates to a method for homomorphically determining the maximum of two messages μₐ and μ_{b}, from the corresponding encrypted messages cₐ and c_{b}, without decrypting the encrypted messages cₐ and c_{b}, the method comprising:
homomorphically determining the quantity H(μₐ−μ_{b}), the Heaviside function H being applied as indicated above, the encrypted version of H(μₐ−μ_{b}) thus determined being noted as h, and
calculating the quantity Maxh=h·cₐ+(1−h)·c_{b}
or, homomorphically determining the quantity H(μ_{b}−μₐ), the Heaviside function H being applied as indicated above, the encrypted version of H(μ_{b}−μₐ) thus determined being noted h′, and calculating the quantity h′·c_{b}+(1−h′)·cₐ.

The present technology also relates to a method for homomorphically determining the minimum of two messages μₐ and μ_{b}, from the corresponding encrypted messages cₐ and c_{b}, without decrypting the encrypted messages cₐ and c_{b}, the method comprising:
homomorphically determining the quantity H(μₐ−μ_{b}), the Heaviside function H being applied as indicated above, the encrypted version of H(μₐ−μ_{b}) thus determined being noted as h, and
calculating the quantity Minh=h·c_{b}+(1−h)·cₐ
or, homomorphically determining the quantity H(μ_{b}−μₐ), the Heaviside function H being applied as indicated above, the encrypted version of H(μ_{b}−μₐ) thus determined being noted h′, and calculating the quantity h′·cₐ+(1−h′)·c_{b}.

The present technology also relates to a method for sorting a database, the database comprising at least, in a first location of the database, a first encrypted message cₐ, and in a second location of the database, a second encrypted message c_{b}, the method comprising writing at least once, in the first location, the quantity Maxh determined in accordance with the method set forth above, or of the quantity Minh, determined in accordance with the method set forth above.

According to one aspect of the present technology, any of the above methods is executed by a computer (programmed or otherwise arranged to execute the method in question), that is to say, an electronic device or system (possibly remotely distributed among several remote devices) comprising at least one processor for performing logical operations, and a memory device for storing data.

The present technology also relates to an encrypted communication and processing method, comprising the following steps of:
encrypting of at least one message μ, with a private key s, by a client, in the form of an encrypted message c, by a learning-with-error type method, the message μ belonging to the discrete torus

$${T}_{p} = \frac{1}{p} \{ - \frac{p - 1}{2} , - \frac{p - 1}{2} + 1 , … , \frac{p - 1}{2} - 1 , \frac{p - 1}{2} \}$$

or to a space in bijection with Tₚ, with

$$p = {\prod }_{i = 1}^{i = q} {p}_{i} ,$$

the integers pᵢ being mutually prime, the encrypted message c=(c₁, . . . , cᵢ, . . . , c_{q}) being formed of q components cᵢ, with

$$c = {\sum }_{i = 1}^{i = q} {v}_{i} {c}_{i} mod ( 1 ) ,$$

vᵢ being the Bézout coefficient associated with the integer pᵢ, defined by uᵢ pᵢ+vᵢ p/pᵢ=1,
transmitting the encrypted message c, or an encrypted database containing the encrypted message c, by the client, to a server distinct from the client and not having the private key s, via a communication channel,
homomorphically processing the encrypted message c, or a difference between the encrypted message c and another encrypted message, or the encrypted database containing the encrypted message c, by the server in accordance with any of the methods described above,
emitting the result of said homomorphic processing by the server.

In this method, the encryption step is optional. Furthermore, the transmission or emission step could be omitted in this method.

This technology also relates to a cryptographic processing server, comprising at least a communication module and a calculation module:
the communication module being configured to receive, from an entity external to the server, an encrypted message c or an encrypted database containing the encrypted message c, the encrypted message c corresponding to a message μ encrypted by a learning-with-error type method, the message μ belonging to the discrete torus

$${T}_{p} = \frac{1}{p} \{ - \frac{p - 1}{2} , - \frac{p - 1}{2} + 1 , … , \frac{p - 1}{2} - 1 , \frac{p - 1}{2} \}$$

or to a space in bijection with Tₚ, with

$$p = {\prod }_{i = 1}^{i = q} {p}_{i} ,$$

the integers pᵢ being mutually prime, the encrypted message c=(c₁, . . . cᵢ, . . . c_{q}) being formed of q components cᵢ, with

$$c = {\sum }_{i = 1}^{i = q} {v}_{i} {c}_{i} mod ( 1 ) ,$$

vᵢ being the Bézout coefficient associated with the integer pᵢ, defined by uᵢ pᵢ+vᵢ p/pᵢ=1,
the calculation module being programmed to process the encrypted message c, or a difference between the encrypted message c and another encrypted message, or the encrypted database containing the encrypted message c, homomorphically, without decrypting the message c, in accordance with any of the (processing) methods described above.

The communication module can be configured to also emit the result of said homomorphic processing.

The present technology also relates to a cryptographic system comprising:
the cryptographic processing server as described above,
a client, configured to encrypt at least one message μ, in the form of the encrypted message c, and to communicate the encrypted message c, or an encrypted database containing the encrypted message c, to the server via a communication channel.

The present technology and its different applications will be better understood upon reading the following description and upon examining the accompanying figures.

### BRIEF DESCRIPTION OF THE FIGURES

The figures are set forth for by way of indicating and in no way limiting purposes.

FIG. 1 schematically represents a cryptographic system implementing the present technology.

FIG. 2 schematically represents an exemplary embodiment of a cryptographic processing server that can be employed in the system of FIG. 1.

FIG. 3 schematically represents another exemplary embodiment of a cryptographic processing server that can be employed in the system of FIG. 1.

FIG. 4 schematically represents yet another exemplary embodiment of a cryptographic processing server that can be employed in the system of FIG. 1, especially for performing processing operations on encrypted databases.

FIG. 5 schematically represents an encryption operation implemented in such a system.

FIG. 6 schematically represents a homomorphic addition operation, component by component, for two messages which have been encrypted by employing the encryption operation of FIG. 5.

FIG. 7 schematically represents a homomorphic multiplication operation, component by component, between two messages which have been encrypted by employing the encryption operation of FIG. 5.

FIG. 8 schematically represents the effect of a scaling operation on a message whose sign is sought to be determined.

FIG. 9 schematically represents a function employed to homomorphically determine the positive or negative character of such a message.

FIG. 10 schematically represents a packet merging method employed to homomorphically determine the positive or negative character of such a message.

FIG. 11 shows an algorithm (in pseudocode) implementing this packet merging method.

FIG. 12 groups together, in the form of a table, values of Bézout coefficients and “dilated” Bézout coefficients employed to homomorphically determine the positive or negative character of such a message, for an exemplary embodiment.

### DETAILED DESCRIPTION

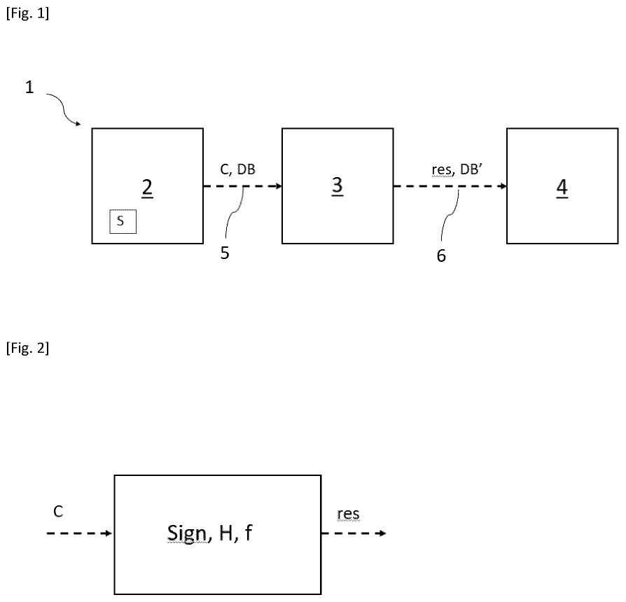

FIG. 1 synoptically represents a cryptographic system 1 comprising:
a cryptographic processing server, 3, and
an entity 2, distinct from the server 3, configured to transmit one or more messages to the server 3, in encrypted form, for example in the form of an encrypted database DB.

Server 3 is configured to perform processing operations (application of a function, comparison, sorting) on the encrypted message(s) received, in a homomorphic manner, i.e. without decrypting the messages. Moreover, server 3 does not have the private encryption key that served to produce the encrypted message(s) from one or more unencrypted plaintext messages.

The entity in question, 2, distinct from the processing server, may be an external database, or a client (in the computational sense), configured to encrypt one or more messages (and, possibly, to collect these messages beforehand), with a private key s, before transmitting the corresponding encrypted message(s) to the server 3, the message(s) being accompanied, for example, with a processing request.

A communication channel 5 connects the entity 2 to the server 3. This is, for example, a communication channel for which the data transmitted are likely to be intercepted. It may be a wireless or wired communication channel. Entity 2 and server 3 may be distant from each other, for example located in different buildings. But they may also be entities belonging to a same computing system, for example within a same electronic device (for example within a same computer, or a same portable electronic device).

The cryptographic system 1 may also comprise a destination entity 4, distinct from the server 3, the result of the homomorphic processing made by the server 3 (a result which is itself encrypted) being transmitted to this destination entity 4, via a communication channel 6. The destination entity 4 may be the entity 2 itself, and the communication channels 5 and 6 may form a same two-way communication channel.

Server 3 comprises a communication module, to receive and/or transmit data (in practice one or more encrypted messages, grouped together for example in the form of the encrypted database DB), and a calculation module, to perform the homomorphic processing operations mentioned above.

The modules in question can take the form of a dedicated electronic circuit, such as a communication board (for the communication module), or a cryptographic calculation circuit comprising at least one processor or programmable circuit, and a memory (for the calculation module). The server itself can thus take the form of a specific electronic device.

The modules in question may also each take the form of a set of instructions whose execution by a computing system (for example by a computer) resulting in performing steps of receiving and/or emitting data (for the communication module), or of processing data (for the cryptographic calculation module). Server 3 may in particular take the form of delocalised computing services, available via a communications network (for example via the Internet or via an intranet), in a delocalised computing structure, for example of the “cloud” type (delocalised structure on several distinct support electronic devices, remote from one another and networked).

Server 3 can be programmed to perform different processing operations homomorphically.

It can, for example, be programmed to apply a piecewise function to a message. This is the case for the server 30 corresponding to the exemplary embodiment of FIG. 2. The piecewise function in question may, for example, be the sign function Sign (which is +1 if the message is positive, −1 if it is negative, and 0 if the message is zero), or the Heaviside function H (which is 0 if the message is zero or negative, and +1 otherwise), or a piecewise function f with more than two pieces.

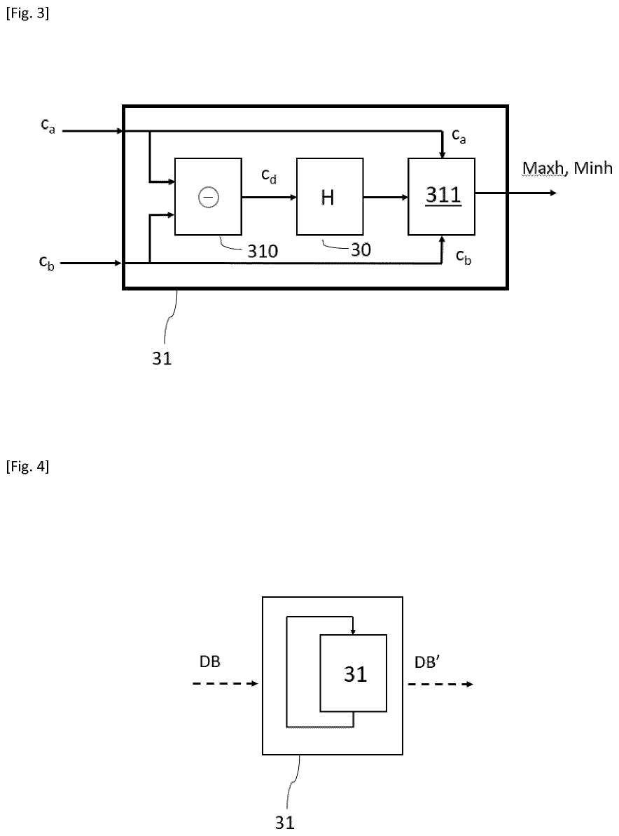

The server can also be programmed to compare two encrypted messages cₐ and c_{b}, by determining the maximum or minimum of these two messages. This is the case for the server 31 corresponding to the exemplary embodiment of FIG. 3.

The server can also be programmed to perform sorting (classification) such messages, in order to sort an encrypted database DB (without decrypting it), to produce a totally or partially sorted database DB′, for example. This is the case for the server 32 corresponding to the exemplary embodiment of FIG. 4.

These different applications are based on a common tool, which is a method for homomorphically determining the positive or negative character of a message (for example via the homomorphic calculation of the sign function, or the heaviside function), or, more generally, for determining the position of this message relative to a discontinuity in a piecewise function.

In the following, there are described:
the encryption scheme employed, based on the so-called “learning with error” encryption method and a decomposition based on the Chinese remainder theorem, and then
the method for homomorphically determining the positive or negative character of a message.

Finally, further details are given to the applications in question.

### Encryption Scheme

As mentioned above, the encryption scheme employed is based on a decomposition into components, or in other words sub-messages, based on the Chinese remainder theorem.

In this scheme, each initial, unencrypted message x belongs to [symbol] ₚ= [symbol] /p [symbol] , with

$$p = {\prod }_{i = 1}^{q} {p}_{i} ,$$

the integers pᵢ being mutually prime.

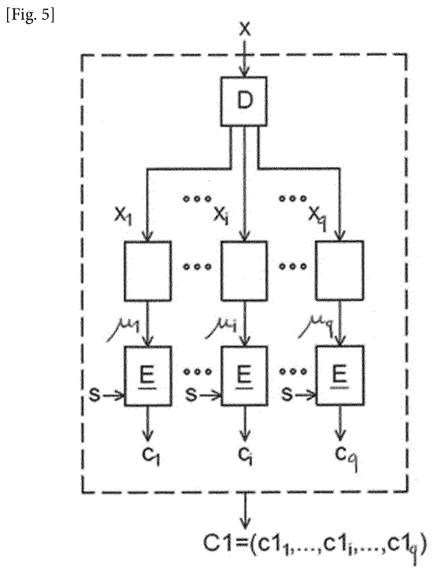

This message can therefore be decomposed into q components xᵢ, each belonging to [symbol] ₚᵢ= [symbol] /pᵢ [symbol] , with xᵢ=x mod(pᵢ) (i.e. modulo(pᵢ)), for i=1 . . . q. This decomposition is performed in step D, in FIG. 5.

For each component xᵢ, a reduced component μᵢ=xᵢ/pᵢ belonging to the discrete torus Tₚᵢ is then calculated, herein.

The message (plaintext) μ=x/p, associated with x, and which belongs to the discrete Torus Tₚ, can thus be decomposed into these q components μᵢ, with

$${μ}_{i} = \frac{p μ}{{p}_{i}} mod 1.$$

Conversely, it is possible to reconstruct the complete message μ from its components μᵢ, by calculating the following quantity:

$$μ = {\sum }_{i = 1}^{i = q} {v}_{i} {μ}_{i} mod ( 1 ) ,$$

vᵢ being the Bézout coefficient associated with the integer pᵢ, defined by μᵢpᵢ+vᵢp/pᵢ=1.

Each component μᵢ is then encrypted, in step E, according to the so-called learning-with-error method, with a private key s, to determine an encrypted component cᵢ. The encrypted component cᵢ=(aᵢ,bᵢ) is determined as follows:
randomly selecting a vector aᵢ, and
calculating the quantity bᵢ=μᵢ+eᵢ+aᵢ·s where eᵢ is a noise component, added to μᵢ+aᵢ·s.

When μᵢ belongs, as herein, to Tₚᵢ, the noise component eᵢ belongs to the torus T=[−½, ½ [.

The complete encrypted message can be represented by its q components cᵢ, i=1 . . . q, in the form c=(c₁, . . . cᵢ, . . . c_{q}). The complete encrypted message can also be explicitly reconstructed, from these components, in the form

$$c = {\sum }_{i = 1}^{i = q} {v}_{i} {c}_{i} mod ( 1 ) ,$$

which directly corresponds to an encrypted version of μ (encryption by learning with error, with the same key s). The term b of the encrypted message c=(a,b) belongs to the torus T=[−½, ½ [, as do the terms bᵢ of its different components cᵢ=(aᵢ,bᵢ).

To decrypt c (or, equivalently, C) each component cᵢ is decrypted (to obtain the plaintext component μᵢ), before recomposing the complete plaintext message μ.

Each component cᵢ is decrypted, by a decryption module having the private key s, by calculating the quantity bᵢ−aᵢ·s (which is equal to μᵢ+eᵢ), and rounding off the result to the nearest value of the discrete torus Tₚᵢ, thus removing the noise component eᵢ to finally obtain μᵢ.

The encrypted component cᵢ, obtained by thus encrypting the component μᵢ, may also be noted \tilde{φ}ₛ(μᵢ).

The encryption scheme is set forth above in the case where the message μ belongs to the discrete torus Tₚ. This encryption scheme can however also be applied when the message μ belongs to a discrete set in bijection with Tₚ, for example when the message belongs to

$${ℤ}_{p} = ℤ / p ℤ = \{ - \frac{p - 1}{2} , - \frac{p - 1}{2} + 1 , … , 0 , 1 , … , \frac{p - 1}{2} - 1 , \frac{p - 1}{2} \} .$$

In any case, as indicated in the “summary” section, this encryption scheme, based on a decomposition according to the Chinese remainder theorem, makes it very efficient to perform operations on the message μ (or, equivalently, on the message x), homomorphically, directly from the encrypted message C=(c₁, . . . cᵢ, . . . c_{q}), without decrypting C. Indeed, several operations, including addition, subtraction, multiplication and bootstrapping (or “refreshing”) can be made directly from the message C, by processing the cᵢ components of c independently of each other (and therefore, possibly, in parallel with each other), and without having to propagate a carried number.

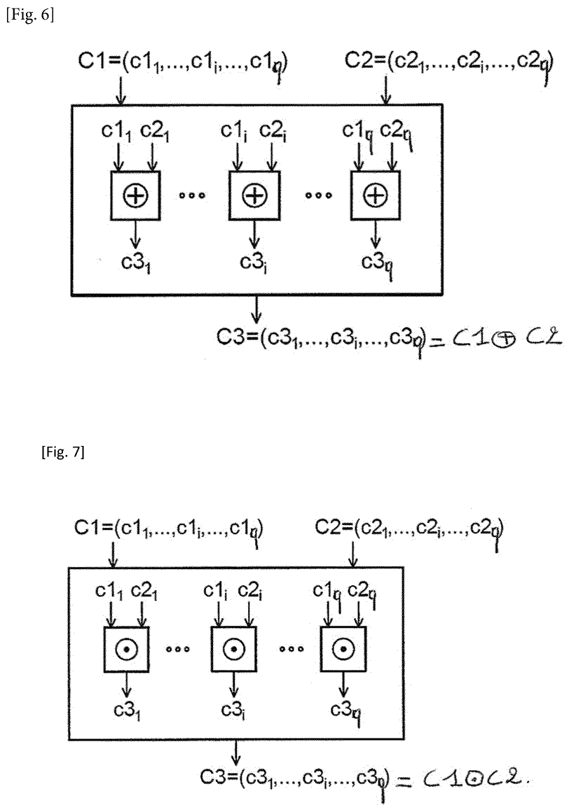

The homomorphic addition of two messages C1 and C2 as described above, each in encrypted form, is thus performed as follows (FIG. 6):

$$C 1 ⊕ C 2 = ( {c 1}_{1} ⊕ {c 2}_{1} , … , {c 1}_{i} ⊕ {c 2}_{i} , … {c 1}_{q} ⊕ {c 2}_{q} )$$

the quantity c1ᵢ⊕c2ᵢ being equal to the term-by-term sum of c1ᵢ and c2ᵢ: c1ᵢ⊕c2ᵢ=(a1ᵢ+a2ᵢ,b1ᵢ+b2ᵢ).

Likewise, the homomorphic multiplication of such messages C1 and C2 as described above, each in encrypted form, is performed as follows (FIG. 7):

$$C 1 ⊙ C 2 = ( {c 1}_{1} ⊙ {c 2}_{1} , … , {c 1}_{i} ⊙ {c 2}_{i} , … {c 1}_{r} ⊙ {c 2}_{r} )$$

Where c1ᵢ⊙c2ᵢ designates a homomorphic multiplication operation of two messages belonging to Tₚᵢ×Tₚᵢ, described in detail in patent application PCT/IB2020/001147, not yet published, and which has been filed by the same applicant (paragraphs 118 to 134, and initial claim 6 of that earlier application; in that earlier application, the notations are generally identical to those employed herein, but the notation u replaces the notation m, and the notation q replaces the notation r).

Likewise, a “refreshed” version C′ of the encrypted message C can be determined by calculating, component by component, the following quantity C′=(G(c₁), . . . G(cᵢ), . . . , G(cᵣ)), where G designates a bootstrapping operation for messages belonging to Tₚᵢ (and which at the same time applies a function g to the plaintext message). This bootstrapping operation is described in more detail in the aforementioned patent application PCT/IB2020/001147, in paragraphs 85 to 117, and in initial claim 3 of that earlier application.

### Homomorphically Determining the Positive or Negative Character of a Message

As explained in the “summary” section, unlike the operations of addition, subtraction, multiplication and bootstrapping, the sign of the message μ cannot be determined from the respective signs of the components of this message.

And determining the sign of the message μ directly from its encrypted version c has difficulties (explained in detail in the “summary” section), because the encrypted message c is affected by a significant noise component

$$e = Err ( μ ) = {\sum }_{i = 1}^{i = q} {v}_{i} {e}_{i} ,$$

which prevents a reliable determination of the sign when μ is close to 0.

Moreover, more generally, as the elements in Tₚ are close (closer together than those in Tₚᵢ), and as the noise component e is significant (larger than the noise component eᵢ affecting the component cᵢ), it is generally not possible to directly decrypt the encrypted message c reliably (decryption involving decrypting each component cᵢ, and then recomposing μ).

By way of example,
for p=p1×p2×p3×p4×p5×p6×p7=7×11×13×15×17×19×23,
and for individual noise components eᵢ whose amplitude is selected so as to obtain correct decryption for each component cᵢ, with a probability of 1-10⁻¹⁰,
it can be demonstrated that the probability of an erroneous decryption of a message μ belonging to Tₚ is greater than 0.65, which clearly shows that a direct and reliable decryption of c (or a direct and reliable determination of its sign) is not possible in practice.

As explained in the “summary” section, two original techniques are provided to overcome this difficulty, and to reliably determine the positive or negative character of the message μ in a homomorphic way, directly from its complete encrypted version c. These are a scaling technique with no (or little) added noise, and a sign merging technique, set forth in more detail below.

### Noise-Free Scaling

When the message μ is close to 0, or to the ½ and −½ edges of the torus T, it is in a zone of uncertainty, where its sign cannot be reliably determined.

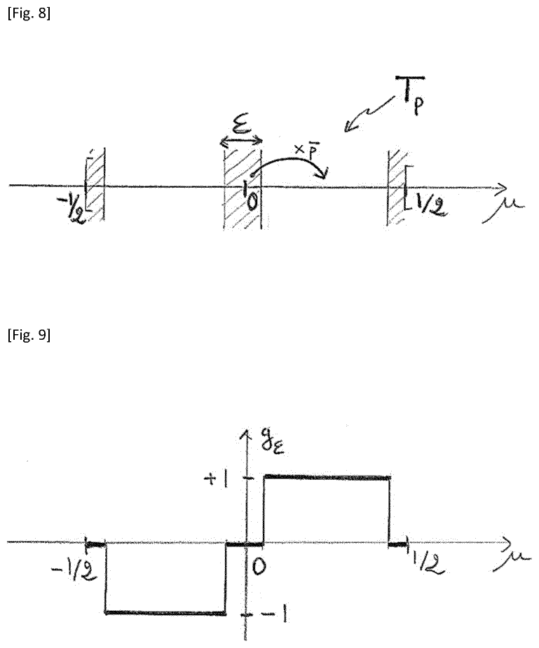

A scaling, or more precisely dilation, operation, which remarkably does not increase the noise affecting the message, can then be used to bring the value of the message out of this zone of uncertainty (FIG. 8). The zone of uncertainty in question corresponds to the intervals: ]−ε/2,ε/2[,]½−ε/2, ½[ and [−½, −½+ε/2[ (where ε is a parameter, set forth later).

This scaling operation consists in calculating a dilated encrypted message c^{[1]}, from the message c (more precisely, from its components cᵢ), in accordance with the following formula

$${c}^{[ 1 ]} = {\sum }_{i = 1}^{i = q} [ \overline{p} {v}_{i} mod ( {p}_{i} ) ] {c}_{i} mod ( 1 ) ,$$

where the dilation coefficient p̅ is an odd number greater than or equal to 3, and less than p.

As explained above, this operation makes it possible to dilate the message μ, but without increasing (or only slightly increasing) the associated noise component.

It is understood that, for some values of μ, such a dilation enables the value in question to be brought out of the zone of uncertainty. However, for other, smaller values, a greater dilation may be necessary to bring the value out of the zone of uncertainty.

Remarkably, considering the series p̅^{k}_{μ}, k=0, . . . , ∞, it is shown that, for

$$0 < {ε}^{′} \leq \frac{1}{2 ( \overline{p} + 1 )} :$$

If μ∈]0, ε′[, then there exists an integer k*∈N* such that for any 0≤k<k*, there is p̅^{k}μ∈]0, ε′[, while p̅^{k}^{^{*}}μ∈[ε′, ½−ε′[; in other words, in the following p̅^{k}, there does exist a dilation coefficient p̅^{k}^{^{*}} for which the dilated message p̅^{k}^{^{*}}μ is outside the zone of uncertainty (i.e.: of determinable sign) and of the same sign as μ (in the following p̅^{k}, this is the first dilation coefficient for which p̅^{k}μ goes out of the zone of uncertainty), and
If μ∈]½−ε′,1/2[, then there is an integer k*∈N* such that for any 0≤k<k*, there is p̅^{k}μ∈]½−ε′, ½ [, while p̅^{k}^{^{*}}μ∈]ε′, ½−ε′]

### Demonstrating the Existence of k* and Bounding its Value

This result can be demonstrated as follows.

First of all, it is noted that:

$$0 \leq μ \leq {ε}^{′} ⇒ 0 \leq \overline{p} μ \leq \overline{p} {ε}^{′} \leq \frac{\overline{p}}{2 ( \overline{p} + 1 )} \leq \frac{1}{2} - {ε}^{′}$$

Furthermore, if μ∈[½−ε′,1/2[, then ½−μ∈]0, ε′], and, likewise as above, there is:

$$\overline{p} ( 1 / 2 - μ ) ∈ [ 0 , 1 / 2 - {ε}^{′} [$$

Taking the symmetric modulo 1, it is obtained that if μ∈[½−ε′, ½[, then p̅μ mod 1∈[ε′, ½[.

Now assume that μ∈]0, ε′[. Let k* be the largest integer such that p̅^{k}μ∈]0, ε′[ for any k=1 . . . k*−1. Such an integer exists because p̅⁰μ∈]0, ε′[ and p̅^{k}μ→∞ if k→∞. Then, as p̅^{k}μ<ε′, there is

$$k < {log}_{\overline{p}} ( \frac{ε}{μ} )$$

Thus, using

$$0 \leq μ \leq {ε}^{′} ⇒ 0 \leq \overline{p} μ \leq \frac{1}{2} - {ε}^{′} ,$$

it is obtained that k* exists and is

$${k}^{*} = ⌈ {log}_{\overline{p}} ( \frac{{ε}^{′}}{μ} ) ⌉$$

where ┌ ┐ designates the next higher integer value.

A symmetrical demonstration shows that when μ∈]½−ε′, ½[, k* also exists and is

$$⌈ {log}_{\overline{p}} ( \frac{{ε}^{′}}{1 / 2 - μ} ) ⌉ .$$

Considering the smallest value of μ on Tₚ, namely 1/(2p), as well as the value closest to ½, namely ½−1/(2p), the following bounding is obtained for k*:

$${k}^{*} \leq ⌈ {log}_{\overline{p}} ( 2 p {ε}^{′} ) ⌉$$

And, more particularly, considering the largest value of ε′ adapted to this protocol, namely

$${ε}^{′} = \frac{1}{2 ( \overline{p} + 1 )} ,$$

there is also:

$${k}^{*} \leq ⌈ {log}_{\overline{p}} ( \frac{p}{\overline{p} + 1} ) ⌉$$

As the value of the message μ is not known (since it is encrypted), during the scaling step, it is provided for calculating several dilated encrypted messages c^{[k]}, with an increasingly large dilation coefficient p̅^{k}, until it is certain that the value of the dilated message μp̅^{k} has gone out of the zone of uncertainty.

In other words, several dilated encrypted messages c^{[k]} are calculated, with a dilation coefficient p̅^{k}, for k=1 . . . K−1, with K selected to be large enough so that K−1 is greater than or equal to the integer k* set forth above (i.e.: so as to be sure that, the series μp̅^{k}, k=1 . . . K−1, at some point will go out of the zone of uncertainty).

For this, given the bounding of the value of k* established above, K is herein selected so that p̅^{K-1}>ε′·2p

K can thus be selected as follows: K−1=┌log_{p̅}(2pε′)┐ or as follows:

$$K - 1 = ⌈ {log}_{\overline{p}} ( \frac{p}{\overline{p} + 1} ) ⌉ .$$

During the scaling step, each dilated encrypted message is determined in accordance with the following formula

$${c}^{[ k ]} = {\sum }_{i = 1}^{i = q} [ {\overline{p}}^{k} {v}_{i} mod ( {p}_{i} ) ] {c}_{i} mod ( 1 ) ,$$

k=1 . . . K−1.

As explained in the “summary” part, in the following μp̅^{k}, k=1 . . . K−1,
for k<k*, the sign of μp̅^{k} cannot generally be reliably determined from its encrypted version c^{[k]},
for k=k*, the sign of μp̅^{k} can be reliably determined from its encrypted version c^{[k]}, and is equal to the sign of the message μ, and
for k>k*, the sign of μp̅^{k} may be false, i.e. no longer equal to the sign of μ.

The different dilated encrypted messages c^{[k]}, k=1 . . . K−1 are then taken into account in a particular way, during the merging step, in order to deduce from these encrypted messages, the sign of the message μ (a sign which is furthermore obtained in encrypted form, since this is a homomorphic calculation method).

### Merging

In the following c^{[k]}, k=0 . . . K−1 (where c^{[0]}=c), which dilated encrypted message is the one allowing a reliable sign determination (i.e.: corresponds to a dilated message located outside the zone of uncertainty), and identical to the sign of μ is unknown. All of these messages are therefore herein taken into account to determine the sign of μ:
a) by assigning the value 0 to the sign (or a function representative of the sign) of each dilated message, if it is in the zone of uncertainty, and
b) by weighting the sign (or a function representative of the sign) of each dilated message with a weighting coefficient att_{[k]} which decreases as k increases, in order to give more weight to the sign of the first dilated encrypted message whose “sign” is non-zero (i.e.: first dilated message which is outside the zone of uncertainty), relative to the signs of the next dilated encrypted messages (whose sign may be “false”, i.e. different from that of μ).

Calculating a weighted sum of these signs (or of values representative of these signs) then makes it possible to homomorphically obtain a result which is positive, negative or zero (for example of value +¼, −¼, 0; or +⅓, −⅓, 0), according to whether the message μ is positive, negative or zero.

Indeed, in this sum:
the terms corresponding to k<k* are zero;
the first non-zero term, associated with the dilated message p̅^{k}^{^{*}}μ (in practice, a term F_{k*}(c^{[k*(])}, set forth below), has a sign which is that of μ, and
the following terms, corresponding to k>k*, possibly have arbitrary signs, but do not modify the sign of the sum, due to the decreasing nature of the attenuation coefficients att_{[k]} (more precisely, due to the fact that the series of coefficients att_{[k]} is such that: the sum of the attenuation coefficients, successively to any of the attenuation coefficients of the series, is less than said attenuation coefficient, which can be obtained for example with a geometric series of common ratio less than ½).

In practice, to implement this merging technique, for each dilated encrypted message c^{[k]}, a quantity Fₖ(c^{[k]}) is calculated, where Fₖ designates an operation of homomorphically calculating the quantity g_{ε}, or even directly, as herein, an operation of homomorphically calculating the quantity att_{[k]}·g_{ε}, where g_{ε} is a staircase function:
which is zero on a central interval]−ε/2, ε/2[,
which has two distinct values, for example −1 and +1 (case of FIG. 9), on either side of this central interval, and
which is zero near the ends of the torus, on the intervals]½−ε/2, ½[ and [−½, −½+ε/2[.

The choice of this function ga (rather than the Sign function) means that value 0 can be assigned to a dilated message located in the zone of uncertainty, in the sum mentioned above.

In practice, the quantity Fₖ(c^{[k]}) is evaluated during a bootstrapping operation (during which the noise is refreshed and, in addition, the function considered is evaluated).

As for the calculation of the sum, i.e. the merging itself, this could possibly be made directly, by calculating the quantity F₀(c)+F₁(c^{[1]})+ . . . +Fₖ(c^{[k]})+ . . . +F_{K-1}(c^{[K-1]}), especially when K is small.

In this case, when the two distinct values of g_{ε} (for a positive and negative message respectively) are −1 and +1, the attenuation coefficients a(k) are preferably selected such that their sum att_{[0]}+ . . . +att_{[k]}+ . . . att_{[K-1]} is less than ½. The result of this sum calculation then belongs to the torus T (which makes it easier to use later, in the encryption scheme employed herein). This condition, as well as the particular decrease condition mentioned above, can be obtained for example by choosing, for the coefficients att_{[k]}, the value A·R^{k}, where the common ratio R of this geometric series is less than ½, and where A is less than (1−R)/2.

Thus, by way of example, it could be selected R=½, and A=¼, i.e. att_{[k]}=½^{2+k}. It could also be selected R=⅓, and A=⅓, i.e. att_{[k]}=⅓^{1+k}.

However, a difficulty arises when calculating such a sum (in particular if K is large). When the first non-zero term in the series Fₖ(c^{[k]}), k=0 . . . K−1 corresponds to a fairly large value of k, it is multiplied by a small attenuation coefficient att_{([k])}, and therefore itself has a small value which is then drowned in noise (which noise inherently affects this sum, since it is the result of a homomorphic calculation, and is therefore supplied in encrypted form, and therefore noisy). This effect can prevent the sign of the sum, and therefore the sign of the message μ, from being determined correctly.

To solve this difficulty, the terms can, as herein, be merged by packets of just a few terms (so that, in each packet, the attenuation coefficients remain relatively large), and do this several times in a row to make this merging progressively. By way of example, each packet may comprise from 2 to 5 terms.

More precisely, this merging by packets can be performed by executing the following steps of:
S1: merging by packets, each packet grouping m terms, each merging of a packet corresponding to calculating the intermediate result resᵢ=F₀(c^{[(i-1)·m]})+F₁(c^{[(i-1)·m+1]})+ . . . +Fₖ(c^{[(i-1)·m+k]})+ . . . +Fₘ₋₁(c^{[i·m-1]}), i being the packet number,
S2: merging by packets of intermediate results resᵢ, each merging of a packet of m′ intermediate results corresponding to calculating a new intermediate result res′ⱼ=\tilde{F}₀(res_{m′·(j-1)})+\tilde{F}₁(res_{m′·(j-1)+1})+ . . . +\tilde{F}ₖ(res_{m′·(j-1)+k})+ . . . +\tilde{F}_{m′-1}(res_{m′·j-1}), j being the packet number, \tilde{F}ₖ designating an operation of homomorphically calculating a quantity att_{[k]}·g_{\tilde{ε}},
step S2 being repeated until only a single result is obtained, to which the operation \tilde{F}₀ is applied, which provides a final result which is an encrypted version of the sign of the message μ.

For example, there can be m′=m.

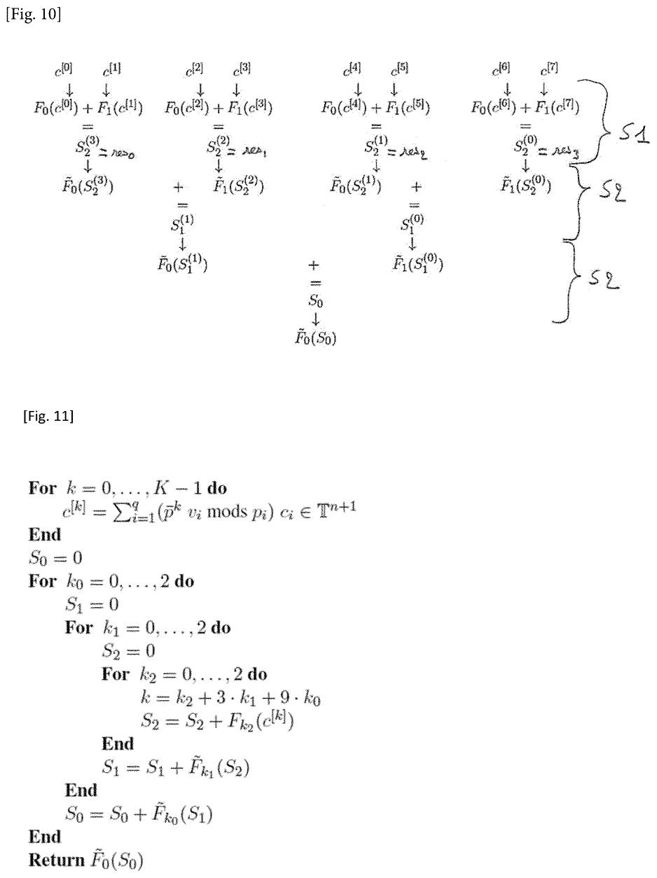

This method of progressive merging by packets is schematically represented in FIG. 10 for a case where K=8 and where each packet comprises two terms, i.e. m=m′=2 (step S2 then being executed twice).

In this figure, each arrow represents a bootstrapping operation, with evaluation of the quantity att_{[k]}·g_{ε} for terms of the Fₖ( ) type, or with evaluation of the quantity att_{[k]}·g_{\tilde{ε}} for terms of the \tilde{F}ₖ type.

\tilde{ε} is another uncertainty width, employed to merge the intermediate results mentioned above (the function g_{\tilde{ε}} is defined in the same way as g_{ε}, but replacing ε with \tilde{ε}). \tilde{ε} is for example equal to 1/(2N), where N−1 is the degree of the specific bootstrapping polynomial W_{g}[X] (see claim 3 of application PCT/IB2020/001147), also noted v[X].

The structure of this calculation of merging by packets remains the same as in FIG. 10 when K has a different value (different from 8), and when the number m of terms per packet is different (different from 2).

Thus, by way of example, a pseudo-code algorithm for performing this merging by packets, for an exemplary embodiment wherein K=27 and m=3 (step S2 also being executed twice, and step S1 once) is represented in FIG. 11.

In any case, during such a merging by packets, for each packet of m terms, the attenuated coefficients of the weighted sum, att_{[k]}, k=0 . . . m−1 satisfy the same conditions as previously (decreasing with k, sum of coefficients following a given coefficient less than this given coefficient, complete sum, from 0 to m−1, less than ½).

For convenience, it can be assumed that K=m^{r} (in the example of FIG. 10, m=2 and r=3, for example), and m′=m. In this case, step S2 is executed r−1 times.

In this case, the result of the entire operation of progressive merging by packets (which result is the sign of μ, being encrypted) can be expressed directly as:

$${\tilde{F}}_{0} ( {{\sum }_{{k}_{0} = 0}}^{m - 1} {\tilde{F}}_{{k}_{0}} ( {{\sum }_{{k}_{1} = 0}}^{m - 1} {\tilde{F}}_{{k}_{1}} ( … {{\sum }_{{k}_{r - 1} = 0}}^{m - 1} {F}_{{k}_{r - 1}} ( {c}^{[ {j}_{k} ]} ) ) ) )$$

$$where {j}_{k} = {\sum }_{i = 0}^{r - 1} {k}_{i} {m}^{r - 1 - i} .$$

### Noise Considerations

A detailed demonstration shows that the method set forth above does indeed enable the sign of a message u to be homomorphically determined, directly from the corresponding encrypted message c, with a very low probability of error.

By way of example, in the case where:
the message μ belongs to Tₚ, with p=p1×p2×p3×p4×p5×p6×p7×p8=7×11×13×17×19×23×25×27 (i.e. p=5,019,589,575>2³²), by choosing the following values for the parameters of the sign determination method: p̅=3, K=21 and ε/2=255/4096≈0,062, it is shown that the probability of error in the homomorphically determining the sign of μ is less than 1.03·10⁻⁹ (which is very low),
the parameters of the encryption scheme being in turn: n=412 (n is the number of components of the secret key s, which belongs to Bⁿ, where B={0,1}, a collapsing parameter I being in turn I=4), N=1024, and a standard deviation σ(eᵢ) of the noise component affecting each component cᵢ which is 2⁻¹⁵\sqrt{200} (which corresponds to a noise level allowing 200 homomorphic additions without bootstrapping between them).

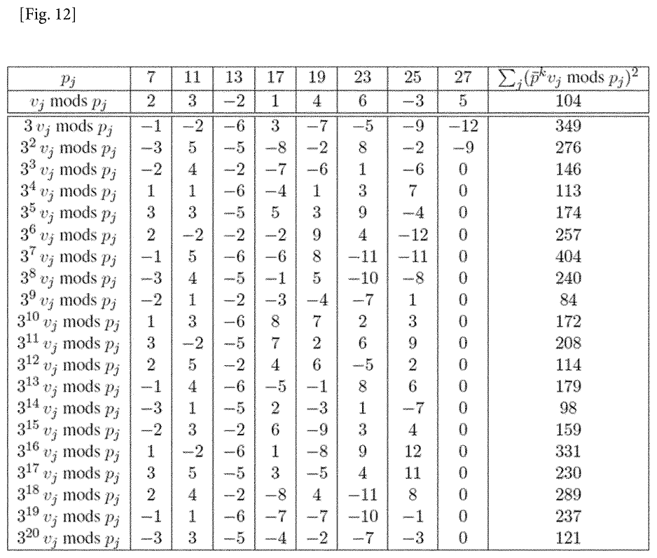

FIG. 12 is a table which, for this example, groups together values of the Bézout coefficients vⱼ, values of the “dilated” Bézout coefficients p̅^{k}vⱼ mod (pⱼ) (which furthermore illustrates that these values remain advantageously small, even though they allow the message to be dilated), and the values of the quantity Σⱼ(p̅^{k}vⱼ mod(pⱼ))², which takes part in calculating the noise affecting dilated encrypted messages.

Details Relating to the Function g_{ε}, and its Emulation by Bootstrapping

The details below are given for an exemplary embodiment for which the attenuation coefficients are att_{[k]}=1/(2^{2+k}). They can be transposed to other values of the attenuation coefficients.

First of all, it is assumed that:

$$∀ k = 0 , … , \vert Err ( {c}^{[ k ]} ) + {δ}^{[ k ]} \vert \leq \frac{ε}{2}$$

where the δ^{[k]}s of

$${φ}_{s} ( {c}^{[ k ]} ) + {δ}^{[ k ]} = {\overline{p}}^{k} μ + Err ( {c}^{[ k ]} ) + {δ}^{[ k ]} \qquad ( 1 )$$

are defined by

$${δ}^{[ k ]} = - \frac{1}{2 N} ( 2 N {b}^{[ k ]} - {\overline{b}}^{[ k ]} - ( 2 N {a}^{[ k ]} - {\overline{a}}^{[ k ]} ) \cdot s ) .$$

The inventors thereby have demonstrated that there exists k* such that
1. If μ>0, then g_{ε}(φₛ(c^{[k*]})+δ^{[k*]})=1 and for any 0≤k<k*, g_{ε}(φₛ(c^{[k]})+δ^{[k]})=0
2. If μ<0, then g_{ε}(φₛ(c^{[k*]})+δ^{[k*]})=−1 and for any 0≤k<k*, g_{ε}(φₛ(c^{[k]})+δ^{[k]})=0
3. If μ=0, then g_{ε}(φₛ(c^{[k]})+δ^{[k]})=0 for any 0≤k
   Emulation of the Function g_{ε}

As detailed in patent application PCT/IB2020/001147, the aim is to construct a polynomial v[X] such that,

$$∀ μ ∈ T , {f}_{v} ( ⌊ 2 N μ ⌉ ) = {g}_{ε} ( μ ) \qquad ( 2 )$$

to emulate the function g_{ε} in encrypted form during a bootstrapping operation.

### Choice of Parameter ε

By construction, the function μ→fᵥ(└2Nμ┐) is a piecewise constant function with possible discontinuities at points uₖ∈[−½,½[ such that

$$2 N {μ}_{k} = \frac{1}{2} + k , k ∈ Z$$

$$that is$$

$${μ}_{k} = \frac{1}{4 N} + \frac{k}{2 N} , k = - N , … , N - 1 .$$

Since the function g_{ε} is odd with discontinuities on the right at ε/2 and ½−ε/2, a natural choice for the parameter ε is

$$ε = \frac{1}{2 N} + \frac{k}{N}$$

under the restriction

$$0 < ε \leq \frac{1}{2 ( \overline{p} + 1 )}$$

$$that is$$

$$0 \leq k \leq ⌊ \frac{N}{2 ( \overline{p} + 1 )} - \frac{1}{2} ⌋ .$$

Construction of the Polynomial v[X]

For any 2N-periodic function F from Z in T such that ∀j∈Z, F(j+N)=−F(j), there exists a unique polynomial v in T_{N}[X] such that ∀j∈Z, fᵥ(j)=F(j).

The coefficients vⱼ of this polynomial are given by vⱼ=F(−j), j=0, . . . , N−1. For a given k, it is therefore sufficient to define F over {0, . . . , N−1}, as follows:

$$∀ 0 \leq j \leq k , \& F ( j ) = 0 ,$$

$$∀ k + 1 \leq j \leq N - k - 1 , \& F ( j ) = 1 ,$$

$$∀ N - k \leq j \leq N - 1 , \& F ( j ) = 0 ,$$

so that vⱼ=F(−j), j=0, . . . , N−1,
that is v₀= . . . =vₖ=0, vₖ₊₁= . . . =v_{N-k-1}=−1, v_{N-k}= . . . =v_{N-1}=0.

For this choice of polynomial and parameter ε, relationship (2) above is actually satisfied without error.

### Rounding Off

During a bootstrapping operation, the value taken by μ in relationship (2) is obtained from φₛ(c^{[k]}) for k=0, . . . , k*, by rounding off the values of

$${a}_{i}^{[ k ]}$$

and b^{[k]} in (a^{[k]}, b^{[k]})=c^{[k]}∈Tⁿ⁺¹ as follows

$${\overline{a}}_{i}^{[ k ]} = ⌊ 2 N {a}_{i}^{[ k ]} ⌉ , i = 1 , … , n , {\overline{b}}^{[ k ]} = ⌊ 2 N {b}^{[ k ]} ⌉ ,$$

and replacing 2Nφₛ(c^{[k]}) with

$${\overline{c}}^{[ k ]} := {\overline{b}}^{[ k ]} - s \cdot {\overline{a}}^{[ k ]} .$$

It will be noted that other alternatives are contemplatable for making these rounding-off operations. The rounding-off process in question introduces errors, which are taken into account via the terms δ^{[k]} in formula (1). Thus, taking relationship (2) and the definition of δ^{[k]} into account:

$${g}_{ε} ( {φ}_{s} ( {c}^{[ k ]} ) + {δ}^{[ k ]} ) = {g}_{ε} ( {b}^{[ k ]} - s \cdot {a}^{[ k ]} + {δ}^{[ k ]} ) = {f}_{v} ( ⌊ 2 N {b}^{[ k ]} - 2 Ns \cdot {a}^{[ k ]} + 2 N {δ}^{[ k ]} ⌉ ) = {f}_{v} ( {\overline{b}}^{[ k ]} - s \cdot {\overline{a}}^{[ k ]} ) = {f}_{v} ( {\overline{c}}^{[ k ]} ) . \qquad ( 3 )$$

The complete bootstrapped function, which provides an encrypted value of

$$\frac{1}{{2}^{l + 2}} {g}_{ε} ( {\overline{p}}^{k} μ + {e}^{[ k ]} + {δ}^{[ k ]} )$$

is

$${F}_{j} ( {c}^{[ k ]} ) := \text{?} ( \frac{1}{{2}^{j + 2}} {f}_{v} ( {\overline{c}}^{[ k ]} ) ) , j = 0 , 1 , …$$

It will be observed that the definition of the δ^{[k]}s can be changed as follows

$$- 1 / 2 \leq 2 N {b}^{[ k ]} - {\overline{b}}^{[ k ]} - s \cdot ( 2 N {a}^{[ k ]} - {\overline{a}}^{[ k ]} ) + 2 N {δ}^{[ k ]} < 1 / 2$$

so that relationship (3) remains valid.

### Bootstrapping the Sign Function

In the case where ½^{k+2} is not too small (attenuation coefficients not too small), the sign of μ can be obtained, for example, by calculating the following quantity (which corresponds to direct merging, and not progressive merging by packets):

$${g}_{\tilde{ε}} ( {\sum }_{k = 0}^{K - 1} \frac{1}{{2}^{k + 2}} {g}_{ε} ( {φ}_{s} ( {c}^{[ k ]} ) + {δ}^{[ k ]} ) )$$

### EXAMPLES OF APPLICATIONS

### Homomorphically Calculating the Heaviside Function

To apply the Heaviside function H homomorphically to the message μ, the homomorphic sign determination method set forth above is applied, but choosing, for the function g_{ε}, the values 0 on [−½+ε/2, −ε/2], and +1 on [ε/2, ½−ε/2] (instead of −1 and +1).

### Homomorphically Calculating any Piecewise Constant Function

To apply any piecewise constant function f to the message μ, the function f having t distinct pieces, the server 3 will, for example, be programmed to execute the following operations:

decomposing the function f as a linear combination of translated Heaviside functions, i.e.

$$f ( μ ) = {\sum }_{j = 1}^{j = t} {α}_{j} H ( μ - {β}_{j} ) ,$$

where the coefficients αⱼ are integers and the abscissas βⱼ of the discontinuity points belong to the interval [−¼, ¼],
calculating the quantity

$${\sum }_{j = 1}^{j = t} {α}_{j} H ( μ - {β}_{j} ) ,$$

each term H(μ−βⱼ) having been homomorphically determined, as indicated above for the Heaviside function H.

### Comparison: Homomorphically Determining the Maximum and Minimum

Let μₐ and μ_{b} be two messages, with Cₐ and C_{b} the corresponding encrypted messages, obtained using the encryption scheme set forth above.

Note that h is the encrypted version of H(μₐ−μ_{b}), determined as explained above (calculation of the Heaviside function).

Because of the linearity of the encryption operations employed herein, the quantity h·cₐ+(1−h)·c_{b} is an encrypted version of μₐ·H(μₐ−μ_{b})+μ_{b}·[1−H(μₐ−μ_{b})], which is none other than the maximum max(μₐ,μ_{b}) of μₐ and μ_{b}.

Calculating the quantity Maxh=h·cₐ+(1−h)·c_{b} this way enables an encrypted version of max(μₐ,μ_{b}) to be homomorphically obtained.

Similarly, calculating the quantity Minh=h·c_{b}+(1−h)·cₐ enables an encrypted version of the minimum min(μₐ,μ_{b}) of μₐ and μ_{b} to be homomorphically obtained.

The server 31 in the exemplary embodiment of FIG. 3 is programmed to perform these operations. Module 310 of this server performs the homomorphic subtraction c_{d}=cₐ⊖c_{b}. And then module 30 determines the quantity h from Cd. Module 311 then performs the operations h·cₐ+(1−h)·c_{b} and h·c_{b}+(1−h)·cₐ and delivers the corresponding results, Maxh and Minh.

Alternatively, the quantities Maxh and Minh could be determined by
homomorphically determining an encrypted version of H(μ_{b}−μₐ), noted h′, and then
calculating the quantity h′·c_{b}+(1−h′)·cₐ (for the maximum) and h′·cₐ+(1−h′)·c_{b} (for the minimum).

Still alternatively, the quantities Maxh and Minh could each be determined from an encrypted version of the sign of the difference μₐ−μ_{b}.

### Sorting a Data Base

Being able to homomorphically determine the maximum and/or minimum of two messages is particularly interesting because it makes it possible to also homomorphically perform sorting (ranking, for example in ascending or descending order) of a set of encrypted messages.

Many sorting algorithms are indeed based on an elementary (repeated) step of message-by-message comparison, i.e. between two of the messages among those to be sorted. One of the two messages is then replaced with the maximum of the two messages, while the other message is replaced with the minimum of the two messages.

The server 32 in the exemplary embodiment of FIG. 4 is programmed to execute a method for sorting an encrypted database DB.

This database comprises at least one first encrypted message cₐ in a first location in the database, and a second encrypted message c_{b} in a second location in the database.

This sorting method comprises at least:
writing, in the first location, the quantity Maxh set forth above, determined from cₐ and c_{b}, or, respectively, the quantity Minh set forth above (determined from cₐ and c_{b}), and
writing, in the second location, the quantity Minh, or respectively the quantity Maxh.

The first and second locations in question can, for example, each be marked in the database by an index number associated with the location considered (for example a row number in a matrix-form database).

1. A method for homomorphically determining the positive or negative character of a message μ from a corresponding encrypted message c, without decrypting the encrypted message c, the encrypted message c corresponding to the message μ being encrypted by a learning-with-error type method, the message μ belonging to the discrete torus
$${T}_{p} = \frac{1}{p} \{ - \frac{p - 1}{2} , - \frac{p - 1}{2} + 1 , … , \frac{p - 1}{2} - 1 , \frac{p - 1}{2} \}$$
or to a space in bijection with Tₚ, with
$$p = {\prod }_{i = 1}^{i = q} {p}_{i} ,$$
the integers pᵢ being mutually prime, the encrypted message c being formed of q components cᵢ, with
$$c = {\sum }_{i = 1}^{i = q} {ν}_{i} {c}_{i} mod ( 1 ) ,$$
vᵢ being the Bézout coefficient associated with the integer pᵢ, defined by uᵢ pᵢ+vᵢ p/pᵢ=1, the method comprising:
a scaling step, comprising determining a dilated encrypted message c^{[1]} in accordance with the following formula
$${c}^{[ 1 ]} = {\sum }_{i = 1}^{i = q} [ \overline{p} {v}_{i} mod ( {p}_{i} ) ] {c}_{i} mod ( 1 ) ,$$
where p̅ is an odd number greater than or equal to 3, and
a merging step, comprising calculating the sum F₀(c)+F₁(c^{[1]}) where F₀ and F₁ respectively designate an operation of homomorphically calculating a quantity att_{[0]}·gε, and a quantity att_{[1]}·gε, gε being a staircase function which is zero on a central interval]−ε/2,ε/2[ and which has two distinct values on either side of this central interval, the coefficient att_{[1]} being less than the coefficient att_{[0]}.

2. The method according to claim 1, wherein the scaling step comprises determinations of several dilated encrypted messages c^{[k]}, the integer k varying from 1 to K−1, each dilated encrypted message being determined in accordance with the following formula
$${c}^{[ k ]} = {\sum }_{i = 1}^{i = q} [ {\overline{p}}^{k} {v}_{i} mod ( {p}_{i} ) ] {c}_{i} mod ( 1 ) ,$$
and wherein the positive or negative character of the message μ is determined as a function of c and as a function of the different dilated encrypted messages c^{[k]}, k=1 . . . K−1.

3. The method according to claim 2, wherein the merging step comprises a step of merging a packet during which the following sum is calculated: F₀(c)+F₁(c^{[1]})+ . . . +Fₖ(c^{[k]})+ . . . +Fₘ(c^{[m]}), where Fₖ designates an operation of homomorphically calculating the quantity att_{[k]}·gε, where att_{[k]} is an attenuation coefficient less than 1, the series of coefficients att_{[k]}, k=0 . . . m being decreasing and such that: the sum of the attenuation coefficients, successively to one of the given attenuation coefficients of the series, is less than said given attenuation coefficient.

4. The method according to claim 3, wherein m is less than K, and wherein the merging step comprises the following steps:
S1: merging by packets, each packet grouping m terms, each merging of a packet corresponding to calculating the intermediate result resᵢ=F₀(c^{[(i-1)·m]})+F₁(c^{[(i-1)·m+1]})+ . . . +Fₖ(c^{[(i-1)·m+k]})+ . . . +Fₘ₋₁(c^{[i·m-1]}), with i being the packet number
S2: merging by packets of intermediate results resᵢ, each merging of a packet of m′ intermediate results corresponding to calculating a new intermediate result res′ⱼ=\tilde{F}₀(res_{m′·(j-1)})+\tilde{F}₁(res_{m′·(j-1)+1})+ . . . +\tilde{F}ₖ(res_{m′·(j-1)+k})+ . . . +\tilde{F}_{m′-1}(res_{m′·j-1}), with j being the packet number, \tilde{F}ₖ designating an operation of homomorphically calculating a quantity att_{[k]}·g_{\tilde{ε},}
step S2 being repeated until only a single result is obtained, to which the operation \tilde{F}₀ is applied, which provides a final result which is an encrypted version of the sign of the message μ.

5. The method according to claim 2, wherein the number K−1 of dilated encrypted messages taken into account is such that p̅^{K-1}>p/(p̅+1).

6. The method according to claim 1, wherein the width ε of the central interval is less than 1/(2p̅+1).

7. A method for homomorphically applying the Heaviside function H, which is zero for negative values and equal to 1 otherwise, the method comprising executing the method for determining the positive or negative character of the message μ according to claim 1, the function gε being selected to be zero for negative values and equal to 1 for positive values.

8. A method for homomorphically applying a piecewise constant function f to a message μ, the function f having t distinct pieces, the method comprising:
decomposing the function f as a linear combination of translated Heaviside functions, i.e.
$$f ( μ ) = {\sum }_{j = 1}^{j = 𝔱} {α}_{j} H ( μ - {β}_{j} ) ,$$
where the coefficients αⱼ are integers and the abscissas βⱼ of the discontinuity points belong to the interval [−¼, ¼],
calculating the quantity
$${\sum }_{j = 1}^{j = 𝔱} {α}_{j} H ( μ - {β}_{j} ) ,$$
each term H(μ−βⱼ) having been homomorphically determined in accordance with the method of claim 7.

9. A method for homomorphically determining the maximum of two messages μₐ and μ_{b}, from the corresponding encrypted messages cₐ and c_{b}, without decrypting the encrypted messages cₐ and c_{b}, the method comprising:
homomorphically determining the quantity H(μₐ−μ_{b}), in accordance with the method for homomorphically applying the Heaviside function H according to claim 7, the encrypted version of H(μₐ−μ_{b}) thus determined being noted h, and calculating the quantity Maxh=h·cₐ+(1−h)·c_{b},
or, homomorphically determining the quantity H(μ_{b}−μₐ), in accordance with the method for homomorphically applying the Heaviside function H, the encrypted version of H(μ_{b}−μₐ) thus determined being noted h′, and calculating the quantity h′·c_{b}+(1−h′)·cₐ.

10. A method for homomorphically determining the minimum of two messages μₐ and μ_{b}, from the corresponding encrypted messages cₐ and c_{b}, without decrypting the encrypted messages cₐ and c_{b}, the method comprising:
homomorphically determining the quantity H(μₐ−μ_{b}), in accordance with the method for homomorphically applying the Heaviside function H according to claim 7, the encrypted version of H(μₐ−μ_{b}) thus determined being noted h, and calculating the quantity Minh=h·c_{b}+(1−h)·cₐ,
or, homomorphically determining the quantity H(μ_{b}−μₐ), in accordance with the method for homomorphically applying the Heaviside function H, the encrypted version of H(μ_{b}−μₐ) thus determined being noted h′, and calculating the quantity h′·cₐ+(1−h′)·c_{b}.

11. A method for sorting a database, the database comprising at least, in a first location of the database, a first encrypted message cₐ, and in a second location of the database, a second encrypted message c_{b}, the method comprising writing at least once, in the first location, the quantity Maxh, determined in accordance with the method of claim 9.

12. An encrypted communication and processing method, comprising the following steps of:
encrypting at least one message μ, with a private key s, by a client, in the form of an encrypted message c, by a learning-with-error type method, the message μ belonging to the discrete torus
$${T}_{p} = \frac{1}{p} \{ - \frac{p - 1}{2} , - \frac{p - 1}{2} + 1 , … , \frac{p - 1}{2} - 1 , \frac{p - 1}{2} \}$$
or to a space in bijection with Tₚ, with
$$p = {\prod }_{i = 1}^{i = q} {p}_{i} ,$$
the integers pᵢ being mutually prime, the encrypted message c=(c₁, . . . cᵢ, . . . , c_{q}) being formed of q components cᵢ, with
$$c = {\sum }_{i = 1}^{i = q} {ν}_{i} {c}_{i} mod ( 1 ) ,$$
vᵢ being the Bézout coefficient associated with the integer pᵢ, defined by uᵢ pᵢ+vᵢ p/pᵢ=1,
transmitting the encrypted message c, or an encrypted database containing the encrypted message c, by the client, to a server distinct from the client and not having the private key s, via a communication channel,
homomorphically processing the encrypted message c, or a difference between the encrypted message c and another encrypted message, or the encrypted database containing the encrypted message c, by the server, in accordance with the method according to claim 11,
emitting the result of said homomorphic processing by the server.

13. A cryptographic processing server comprising at least a communication module and a calculation module:
the communication module being configured to receive, from an entity external to the server, an encrypted message c or an encrypted database containing the encrypted message c, the encrypted message c corresponding to a message μ encrypted by a learning-with-error type method, the message μ belonging to the discrete torus
$${T}_{p} = \frac{1}{p} \{ - \frac{p - 1}{2} , - \frac{p - 1}{2} + 1 , … , \frac{p - 1}{2} - 1 , \frac{p - 1}{2} \}$$
or to a space in bijection with Tₚ, with
$$p = {\prod }_{i = 1}^{i = q} {p}_{i} ,$$
the integers pᵢ being mutually prime, the encrypted message c=(c₁, . . . cᵢ, . . . c_{q}) being formed of q components cᵢ, with
$$c = {\sum }_{i = 1}^{i = q} {ν}_{i} {c}_{i} mod ( 1 ) ,$$
vᵢ being the Bézout coefficient associated with the integer pᵢ, defined by uᵢ pᵢ+vᵢ p/pᵢ=1,
the calculation module being programmed to homomorphically process the encrypted message c, or a difference between the encrypted message c and another encrypted message, or the encrypted database containing the encrypted message c, without decrypting the message c, in accordance with the method according to claim 1,
the communication module being also configured to emit the result of said homomorphic processing.

14. A cryptographic system (1) comprising:
the cryptographic processing server according to claim 13,
a client, configured to encrypt at least one message μ, in the form of the encrypted message c, and to communicate the encrypted message c, or an encrypted database containing the encrypted message c, to the server via a communication channel.

15. A method for sorting a database, the database comprising at least, in a first location of the database, a first encrypted message cₐ, and in a second location of the database, a second encrypted message c_{b}, the method comprising writing at least once, in the first location, the quantity Minh, determined in accordance with the method of claim 10.
